(19) United States
(12) Patent Application Publication
(10) Pub. No.: US 2012/0109768 A1
(43) Pub. Date: May 3, 2012

(54) Method and Arrangement for Enabling a Media Purchase

(75) Inventor: Joakim Söderberg, Solna (SE)

(73) Assignee: TELEFONAKTIEBOLAGET L M ERICSSON (PUBL), Stockholm (SE)

(21) Appl. No.: 13/380,820

(22) PCT Filed: Jun. 25, 2009
(86) PCT No.: PCT/SE2009/050812

§ 371 Date: Dec. 24, 2011

(51) Int. Cl. G06Q 30/06

(52) U.S. Cl. 705/26.1

(57) ABSTRACT

A method and arrangement for enabling a purchase of a media object for a user operating a user terminal (200). The media object is owned by a media provider (204) and is presented to the user by a media sender (202) controlled by a media sending party. The user terminal obtains (2:2) from the media sender a media ID that identifies the media object and a sender ID that identifies the media sender. When receiving (2:3) an input command from the user, the terminal makes (2:4) a purchase request referring to the media ID and sender ID, which may be sent to the user's home network operator (206) or to the media provider or to a separate purchase handler. The media provider then delivers (2:7) the media object to the user, the user is charged (2:10) for the media purchase, the media provider receives payment for the purchase, and the media sending party receives compensation (2:9) for the user's purchase of the media object.

### TECHNICAL FIELD

The present invention relates generally to a method and arrangement for enabling a purchase of media being presented to a user of a terminal, e.g. music or a movie.

### BACKGROUND

Recently, consumers of audio and video media have tended to change their habits of acquiring such media. The general trend is thus moving from buying CD:s and DVD:s to downloading and streaming the media over the Internet. The Internet is also used extensively to find media of interest from Internet stores or the like and from various social networks and communities, e.g. Facebook, Myspace and Lastfm. One typical example is to find music or movies by searching and browsing the Internet, and then downloading a desired music file from a content or media provider to a user terminal by payment from a credit card. Further, the software application known as “iTunes” has become widely popular and provides functionality for media playing and podcast management as well as for purchasing and downloading music files from the online media store called “iTunes Store”.

Radio and TV programs can also be received over the Internet as an alternative to receiving broadcasted signals by means of an “old-fashioned” radio or TV receiver in the traditional manner. For example, radio companies can offer Internet radio broadcasted live in real-time as a streaming service, which is widely used for mobile terminals since downloading corresponding audio files would require considerable memory capacity often lacking in such terminals.

For example, if an end-user is listening to a song received by means of a streaming service or otherwise, he/she may wish to purchase that song either as a CD or by downloading an audio file. In order to do that, there must be some way that the user can identify the song if not recognised anyway. Even if the song is announced by a speaker in the radio program, which is certainly not always the case, the user may not be able to hear it or remember it later on. For streaming services, a mechanism has been devised for informing listeners on what is currently being played by presentation on the terminal display, according to the prior art, which will be briefly described with reference to FIG. 1.

A streaming server 100 receives broadcasted live radio channels from one or more radio stations 102, either in regular radio broadcasts as shown in the figure, or by means of fixed wireline connections. Any of the received live radio channels can then be transmitted upon request from the server to user terminals practically in real-time by means of the streaming technique.

In this example, a user terminal 104 receives a media stream from the streaming server 100, which is played out at the terminal 104. Conventionally, certain information regarding the transmitted media is also transmitted in a separate channel simultaneously, often referred to as “metadata” or “meta information”. For example, such metadata may include information on a particular piece of music currently being played, typically the title and artist, and also further information on what will be played next, etc.

This information can then be displayed at the receiving terminal 104 during play-out of the music piece. Thereby, the user is able to identify the played music piece and later purchase it from a media provider 106, e.g. over the Internet or in a CD shop or the like. However, the user must still detect or register the displayed information on a played media piece and either take a note or remember it until making the purchase at a later point. When buying music or movies over the Internet, a manual registration procedure must also be conducted in order to execute the purchase, typically involving the submission of a credit card number, identification and/or login parameters, and so forth. As a consequence, the user may well refrain from these efforts or simply forget about it, particularly in the case of buying a single song, even though he/she would actually desire the played media piece, also resulting in missed revenue for media or content providers.

WO 2008/002208 A1 (Ericsson) discloses that media received from a streaming server can be purchased by means of a download enabler which is used for downloading the media object from a download server.

### SUMMARY

In this description, the term “media provider” should be understood in a broad sense as a party capable of delivering content in the form of media in any manner to a user buying the content, generally referred to as a “media object”. For example, the content may be delivered either physically as stored on CD:s, DVD:s to a delivery address as specified or predefined by the user, or electronically by downloading or streaming the content to the user's communication equipment.

When buying media over the Internet, safety often becomes an issue to be solved for both the user buying the media and the media provider. A trusted relation is thus desirable for both parties which involves procedures for reliable authentication and safe payment. A more convenient and reliable mechanism for purchasing media is therefore needed requiring a minimum of effort and attention from the user for making a purchase of media being played or otherwise presented. It is also desirable to facilitate the purchase process for both media buying users and media providers, and to enable increased sales in general for media providers.

It is an object of the invention to address at least some of the issues outlined above. In particular, it is an object to provide a solution which enables safe and convenient purchase of media as well as revenue for at least the media providers. These objects and others can be achieved primarily by a solution according to the appended independent claims.

According to different aspects, methods and arrangements are defined for enabling the purchase of a media object for a user operating a user terminal. It is assumed that the media object is owned by a media provider and is currently presented by means of a media sender controlled by a media sending party, such that the media object can be received and experienced by the user.

In one aspect, a method is provided which enables a purchase of a media object for a user operating a user terminal, the media object being owned by a media provider. The media object or a representation thereof is presented to the user by means of a media sender controlled by a media sending party. A media ID that identifies the media object and a sender ID that identifies the media sending party, are also conveyed from the media sender to the user terminal.

When receiving an input command from the user for buying the media object, the user terminal sends a purchase request referring to the media and sender ID:s, wherein the media sending party can be identified based on the sender ID in order to provide compensation to the media sending party for the user's purchase of the presented media object. This solution provides a convenient mechanism for purchasing media objects by simply making an input command when the media object is presented by the media sender.

Different embodiments are possible in the method above. In one embodiment, a media provider ID identifying the media provider, is also conveyed from the media sender to the user terminal. In another embodiment, at least one of the ID:s above is conveyed from an NFC unit in the media sender to an NFC unit in the user terminal. In that case, the media object or representation thereof may be played out by the media sender and the user terminal may obtain at least one of the ID:s by sending a media query to the media sender regarding the media object, when receiving the purchase command from the user.

Further, if the media object or representation thereof is played out by the media sender, at least one of the ID:s above may also be conveyed from the media sender to the user terminal as overlaid information on the media object.

In further embodiments, the media object or representation thereof is presented to the user by being played out or otherwise offered, announced, illustrated, disclosed or displayed by the media sender. If a network operator serving the user receives the purchase request, the operator sends a delivery request to the media provider for delivery of the media object to the user, charges the user for the purchase of media object(s), provides payment to the media provider for delivering the media object, and provides the compensation to the media sending party. In that case, the network operator may also have a trusted relation with the media provider, in the sense that the network operator takes responsibility for charging the user and providing payment to the media provider for the purchase of the media object, and the media provider delivers the media object to the user.

In further embodiments, the user may also be checked with respect to predefined purchase rules to find out if the purchase of the media object can be permitted. The predefined purchase rules may be dependent on one or more of: identity of current terminal user, location of current user, previous payments of bills, money available on the user's account, the sum, size or price of the media object, type of media object, current time of day, week or season, and currently available network bandwidth. The purchase rules may further be differentiated for different users or terminals, thereby depending on which user has logged on to the terminal, or on capabilities of the terminal.

When the media provider or a separate purchase handler receives the purchase request, the user's credibility may be checked to determine whether the purchase of the media object can be permitted, and if so, the compensation can be provided to the media sending party.

In another aspect, an arrangement is provided in a media sender for enabling a purchase of a media object for a user operating a user terminal, the media object being owned by a media provider and the media sender being controlled by a media sending party. This media sender arrangement comprises a presenting unit adapted to present the media object or a representation thereof to the user, and conveying means adapted to convey a media ID to the user terminal that identifies the media object, and to convey a sender ID to the user terminal that identifies the media sending party. The user terminal is then able to make a purchase request referring to the media and sender ID:s upon receiving a purchase command from the user.

In one embodiment, the media sender arrangement comprises an NFC unit adapted to send out at least one of the media and sender ID:s over an NFC link. The NFC unit may further be adapted to send out at least one of the media ID and sender ID in response to a media query from the user terminal regarding the media object. In further embodiments, the presenting unit is also adapted to play out at least a part of the media object, and to convey at least one of the media ID and sender ID to the user terminal as overlaid information on the played-out part of the media object. The conveying means may also be adapted to convey a media provider ID to the user terminal that identifies the media provider.

In another aspect, an arrangement is provided in a user terminal for enabling a purchase of a media object for a user operating the user terminal, wherein the media object or a representation thereof is presented by a media sender to the user, the media object being owned by a media provider and the media sender being controlled by a media sending party. The user terminal arrangement comprises an input unit adapted to receive an input command from the user for purchasing the media object, obtaining means for obtaining from the media sender a media ID that identifies the media object and a sender ID that identifies the media sender, and a purchase requester adapted to make a purchase request referring to the obtained media ID and sender ID when receiving the input command. The media provider is then able to deliver the media object based on the media ID in response to the purchase request, and compensation can be provided to the media sending party, based on the sender ID, for the user's purchase of the media object.

In one embodiment, the obtaining means comprises an NFC unit adapted to receive the media ID and sender ID from the media sender over an NFC link. In that case, the media object or representation thereof may be played out by the media sender and the NFC unit may be further adapted to receive the media ID and sender ID from the media sender during play-out of the media object. The NFC unit may be further adapted to send a media query to the media sender regarding the media object, upon receiving the input command from the user, and to receive the media ID and sender ID in response to the media query.

In further embodiments, the media object or representation thereof is played out by the media sender and the obtaining means is further adapted to receive the media and sender ID:s as overlaid information on the played-out media object or representation thereof. The purchase requester may be further adapted to send the purchase request to a network operator serving the user, or to the media provider or to a separate purchase handler.

In yet another aspect, an arrangement is provided in a purchase control unit configured to enable a purchase of a media object for a user operating a user terminal. Again, the media object or a representation thereof is presented by a media sender to the user, the media object is owned by a media provider, and the media sender is controlled by a media sending party. The purchase control unit arrangement comprises a purchase manager adapted to receive a purchase request from the terminal referring to a media ID that identifies the media object and a sender ID that identifies the media sending party, wherein the user terminal has obtained the media ID and sender ID from the media sender, and a delivery requester adapted to send a delivery request to the media provider or to an associated separate delivery handler referring to the media ID such that the media object can be delivered to the user. The purchase manager is further adapted to identify the media sending party based on the sender ID and to provide compensation to the media sending party for the user's purchase of the media object.

In one embodiment, the purchase manager is further adapted to check the user with respect to predefined purchase rules to find out if the purchase of the media object can be permitted. The predefined purchase rules may be dependent on different factors as outlined above, and may also be differentiated for different users or terminals.

In another embodiment, the purchase manager is further adapted to provide payment to the media provider for the user's purchase of the media object, and to charge the user for the purchase. The purchase control unit may be located at or controlled by any of the media provider, a network operator serving the user, and a separate purchase handler.

In yet another aspect, a method is provided in a media provider of enabling a purchase of a media object for a user operating a user terminal. Again, the media object is owned by the media provider, wherein the media object or a representation thereof is presented to the user by a media sender controlled by a media sending party. In this method, a purchase request is received from the user terminal referring to a media ID that identifies the media object and a sender ID that identifies the media sender, wherein the terminal has obtained the media ID and sender ID from the media sender. The media object is then delivered to the user based on the media ID in response to the purchase request, the media sending party is identified based on the sender ID, and compensation is provided to the media sending party for the user's purchase of the media object. The received purchase request may also refer to a preferred delivery address to which the media object can be delivered.

Using the invention as described above, media objects can be purchased in a safe and relatively simple manner requiring a minimum of effort and attention from the user, particularly when small sums are involved. Another advantage is that revenue for media object purchases can be received not only by the media provider selling the media objects, but also by the media sending party presenting the media objects that are purchased by the user, and optionally also by a separate purchase handler handling the purchases. This solution enables the media sending party to receive revenue when the presentation of a media object to a user incurs the user to buy the media object from the media provider. Further features and benefits of the invention will become apparent from the detailed description below.

### BRIEF DESCRIPTION OF THE DRAWINGS

The invention will now be described in more detail by means of exemplary embodiments and with reference to the accompanying drawings, in which:

FIG. 1 is a basic overview of a procedure of purchasing streamed media, according to the prior art.

FIG. 2 is a basic overview of a procedure and arrangement for enabling a purchase of a media object being presented to a terminal user, in accordance with some exemplary embodiments.

FIG. 3 is a flow chart illustrating a procedure in a user terminal for enabling a purchase of a media object, in accordance with one embodiment.

FIG. 4 is a flow chart illustrating a procedure in a purchase control unit for enabling a purchase of a media object, in accordance with another embodiment.

FIG. 5 is a signalling diagram illustrating a procedure for enabling a purchase of a media object, in accordance with further embodiments.

FIG. 6 is a block diagram illustrating arrangements in a user terminal, a media sender and a purchase control unit, for enabling a purchase of a media object, in accordance with further embodiments.

FIG. 7 is a basic overview of a procedure and arrangement for enabling a purchase of a media object being presented to a terminal user, in accordance with further embodiments.

FIG. 8 is a flow chart illustrating a procedure in a purchase handler for enabling a purchase of a media object, in accordance with another embodiment.

FIG. 9 is a basic overview of a procedure and arrangement for how identities can be handled to enable a purchase of a media object for a terminal user, in accordance with further embodiments.

### DETAILED DESCRIPTION

Basically, the invention provides a solution where a user, listening to or viewing a presentation of a media object or a representation thereof being presented by means of a media sender, can initiate a purchase of the media object from an associated or affiliated media provider simply by making an input command at his/her user terminal. The terminal then automatically takes actions to execute the purchase of the media object in a manner to be described below. The entire purchase is thus completed automatically and no further efforts are required from the user.

In this description, the term “media object” should be understood in a broad sense to represent any type of audio, video, image, text or software, typically a piece of music, a film or movie, fixed or moving images, although the invention is not limited thereto. A representation of the media object could be an announcement, advertisement or acknowledgement referring to the media object in any suitable manner, e.g. in sound, images, text, animation or any combination thereof. A presentation of a media object or a representation thereof is hereinafter jointly referred to as a presentation of the media object. The media object may thus be presented to the user by presenting or disclosing the media object itself or a representation of the media object.

Further, the purchase may be controlled and charged for by a home network operator of which the user is a subscriber, or by a separate party which will be referred to as a “purchase handler”, e.g. similar to the known so-called “Pay Pal”. The purchase handler has a trusted relation with the media provider and is configured to handle various charging and compensation functions to be described in more detail later below. A purchase handler function may also be implemented at the content provider for controlling and charging the purchase, to be described in more detail below.

In this solution, an affiliated media sending party basically presents a media object by means of a media sender equipment, and the presentation is received and experienced by a person operating a user terminal. In this description, the term “media sender” thus basically refers to the media presenting equipment used by the media sending party responsible for presenting the media object to anyone able to observe it. The media sender may be a suitable play-out unit or other presenting equipment or means.

The media object is “owned” by the media provider, at least technically speaking, and may be audio media played out through a loudspeaker or visual media such as video or images played out through a video playing apparatus or the like, which is controlled by a media sending party, e.g., a radio or TV broadcast company or a disc jockey.

Alternatively, the media object may be presented to a user by being offered, announced, illustrated, disclosed or displayed in any manner without limitation to this solution.

The media object may thus be presented in different ways, e.g. played out or otherwise disclosed. The media object may further be played out more or less in its entirety or just a limited part thereof could also be played out. For example, a teaser, trailer or other presentation relating to the media object may be disclosed to the user in a suitable manner. The invention is thus not limited to any specific way of presenting the media object.

Effectively, the media sending party can thus be affiliated to the media provider to suggest, advertise or recommend the presented media object in any manner to those receiving the presentation in order to promote sales of the media object.

The media sender also sends out metadata or meta information over a wireless communication interface, the metadata comprising a sender identity, “sender ID”, which identifies the media sending party, and also comprising a media identity, “media ID”, which identifies the media object currently being presented. This metadata is obtained by the user terminal which then, upon receiving a user input command, can send a purchase request including at least the received sender and media identities. According to different embodiments, the purchase request can be sent directly to the media provider owning the media object, or to a purchase control unit or the like controlled by a separate purchase handler or by the home network operator, to be described further below. In either case, the purchase request may be received and handled by a logical purchase control unit or the like that may belong to the media provider, purchase handler or home network operator.

For example, the metadata can be sent from the media sender to the terminal on a separate wireless communication link by means of a suitable NFC (Near Field Communication) equipment comprising an NFC sender at the media sender and an NFC receiver at the user terminal, e.g. using Bluetooth, infrared or any other NFC technique. The metadata could also be sent out from the media sender as overlaid, encapsulated or integrated information in the media presentation, when the media object is presented by means of wireless transmission, e.g. coded into a played audio stream using so-called watermarking algorithms in a manner known per se. The term “NFC” is used here to broadly represent any wireless communication mechanism that can be used for conveying the above metadata locally from the media sender to the terminal. Furthermore, the above sender and media ID:s need not be sent from the media sender in the same way but could be sent by different independent mechanisms. For example, the sender ID could be sent on a separate NFC link such as Bluetooth while the media ID could be encapsulated or integrated in the media presentation, or vice versa.

As mentioned above, the purchase request may be sent to and handled by the media provider, the home network operator or a separate purchase handler. If the terminal makes the purchase request to the home network operator or to an associated purchase handler, the media provider will be requested by the home network operator or by the purchase handler to deliver the media object identified by the received media ID. In that case, it is assumed that the home network operator or purchase handler have established a trusted relation or corresponding agreement with the media provider. The media provider may then receive payment from the home network operator or purchase handler for the media delivery. In turn, the user can be charged for the purchase of media object(s) by his/her operator, e.g. on a regular subscription bill, or by means of a separate bill, or by deduction in real time from the user's charging account.

Compensation or a commission fee can further be provided to the affiliate media sending party for the media purchase as well, as identified from the above-mentioned sender ID. In this description, the term “compensation” refers to any economic reward to the media sending party for an executed purchase, regardless of the procedure or mechanism used. It can thus be readily understood that this technical solution enables various different business models that may be valuable for any one or more of the user, the home network operator, a purchase handler if used, the media provider and the media sending party.

Before requesting the media provider to deliver the media object, the home network operator or purchase handler may check whether the user can be permitted to buy the wanted media object, which may be subject to subscription conditions and/or predefined purchase rules or policies. For example, it may be required that the user has paid his/her previous bills properly, or that the price or size of the media object does not exceed a preset limit. In other examples, specific purchase rules or policies may be defined for different users such that a child under age is not permitted to purchase films suitable for adults only, or that a specific user is permitted to purchase only a limited amount of media data or a certain type of media (e.g. only audio), or that media objects can only be purchased at certain times of day, week or season, and so forth. The latter condition may be useful at hours of intense data traffic when it is desirable to limit the traffic and avoid congestion in the communication networks used.

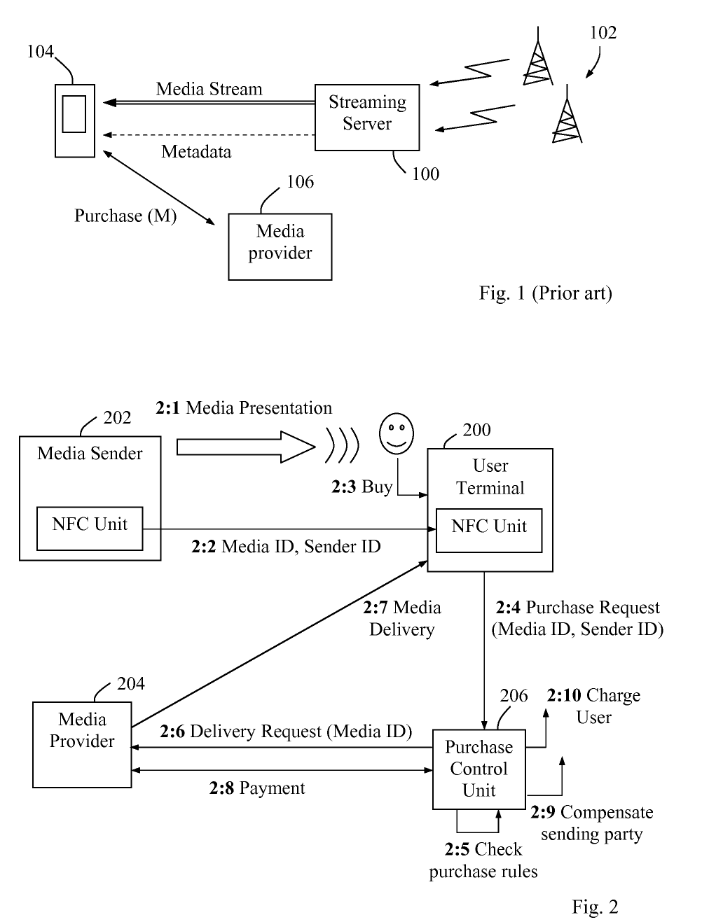

An exemplary procedure for enabling a purchase of a media object when presented to a terminal user, will now be described with reference to FIG. 2. The user operates a user terminal 200, and the media object or a representation thereof such as a teaser, trailer or other disclosure is presented by means of a media sender 202 controlled by a media sending party. The presented media object is further owned by a media provider 204 and the purchase is handled by a purchase control unit 206.

In this example, the purchase control unit 206 belongs to a home network operator having the user as a subscriber. However, the described function of the purchase control unit 206 could alternatively be implemented at the media provider 204, or as controlled by a separate purchase handler such as a Pay Pal or the like.

The home network may be a mobile or fixed access network or an IMS (IP Multimedia Subsystem) network. It is further assumed that the home network operator and the media provider have established a trusted relation in the sense that the home network operator takes responsibility for charging a subscriber/user for the purchase of a media object and providing payment for the purchase to the media provider, who delivers the media object to the subscriber or otherwise as specified by the subscriber.

A first step 2:1 illustrates that the media object or representation thereof is generally presented by the media sender 202, and the presentation is received and experienced by the user of terminal 200. This may be done in different ways without limitation to the invention, and the media sender 202 may present the media object or a representation thereof through loudspeakers or a TV screen at a more or less public space such as a discotheque, restaurant or a shop, or in a more private space such as in a home or car.

Alternatively, the media sender 202 may present the media object by sending out a data stream which is received by the terminal 200 over a suitable communication link, e.g. Bluetooth, and presented on the terminal in the form of audio, video, image or text, and so forth. In that case, the data stream may be conveyed over a packet data network or locally by means of sending and receiving NFC units or the like in the media sender 202 and terminal 200, respectively.

At the same time, as shown in a step 2:2, the media sender 202 also sends out metadata from its NFC unit, comprising a sender ID identifying the media sending party and a media ID that identifies the media object currently being presented. The metadata sent by media sender 202 may also include a media provider identity “MPID” identifying the media provider that owns the presented media object.

The media ID may be an identity according to a known media identification standard, such as “GRID” (Content Reference Identifier), “DII” (MPEG-21 Digital Item Identifier), “UPC” (Universal Product Code) or “ISAN” (International Standard Audiovisual Number). The sender ID may be a subscriber identity according to the IMS standard, known as “ISIM” (IMS Subscriber Identity Module). It is also possible to send any of the ID:s above as attributes of an existing metadata format, e.g. the known “Adobe XMP Metadata” format using any of the following attributes as identifier: xmp:identifier or Dublin Core: dc:contributor, dc:publisher and dc:creator. In this step, the media and sender ID:s are thus generally obtained by the terminal 200 from media sender 202.

A next step 2:3 illustrates that the user makes an input command at the terminal 200 for purchasing the presented media object, being currently played or otherwise disclosed, e.g. by pressing a “buy” button or the like on the terminal. Terminal 200 is configured with software functionality to create a purchase request message which includes at least the currently received media ID and sender ID, and the message is then automatically sent to the purchase control unit 206 in response to the input command, in a further step 2:4. If the MPID is included in the metadata, it may further be possible to configure the MPID such that the terminal can construct a HTTP (HyperText Transfer Protocol) link from the MPID, such as a URL (Universal Resource Locator), which is also typically utilised for CRID:s. The terminal is thereby able to send the purchase request using the HTTP link.

Since the user of terminal 200 is known as a subscriber in the home network, the received purchase request can in this example be managed accordingly, i.e. without requiring further identification and authentication of the user and his/her terminal. Alternatively, the terminal may send the purchase request to the media provider or to a separate purchase handler, which will be described later below with reference to other examples. The software functionality may be installed in the terminal when manufactured, or obtained from a server or the like, which is however outside the scope of this invention.

In an optional next step 2:5, the purchase control unit 206 may check whether the subscriber is permitted to execute the requested purchase, which may be subject to conditions in the subscription and/or predefined purchase rules or policies. In this description, the term “purchase rules” is used to represent any such rules, policies or subscription conditions that may dictate whether a requested purchase of media object(s) can be permitted or not. The purchase rules may have been stored in a rules database, not shown here, that can be accessed by the purchase control unit 206.

As indicated above, the purchase rules may be dependent on any of the following limitation factors separately or in combination: identity of current terminal user, location of current user, previous payments of bills, money available on the user's account, the amount, size or price of the requested media object, type of requested media, current time of day, week or season, and currently available network bandwidth. The purchase rules may thus be differentiated for different users or terminals, thereby depending on which user has logged on to the used terminal, or capabilities of the terminal. In this step, the user's credibility may also be checked, e.g. by contacting a bank or account associated with the user, to see if the requested purchase can be permitted and safely executed.

Assuming that the requested purchase of media object(s) can be permitted, the purchase control unit 206 is able to identify the media provider 204 from the received purchase request, e.g. by applying a resolve mechanism to the received media ID and/or sender ID. Purchase control unit 206 then sends a request to the media provider 204 for delivering the media object, e.g. electronically to the user terminal 200 or physically to a preferred delivery address, in a further step 2:6. As the home network operator and the media provider have a trusted relation in this example, they may also have established a dedicated communication channel for conveying the delivery request. However, any suitable communication link or channel may be used in this step and the invention is not limited in this respect.

Accordingly, the media provider 204 then delivers the media object to the user terminal 200, as schematically illustrated in a following step 2:7, or alternatively to a preferred delivery address. In this step, delivery of the media object can be done in different ways without limitation to the invention. For example, the media object can be delivered electronically to the user terminal 200, e.g. as an uploaded media file. In that case, the media file can be protected using a technology known as DRM (Digital Rights management) which enables the user to play the media on other devices such as a stereo or TV equipment. The media object can also be delivered to the user as carried by a physical medium, e.g. a CD, DVD or other data carrier unit.

In a next schematic step 2:8, media provider 204 receives payment from the home network operator for the media delivery of step 2:7 in a suitable manner. This operation may be accomplished in different ways without limitation to the invention. For example, the media provider 204 may send an account claim to the purchase control unit 206 which then could send a notification for settlement of account to media provider 204.

As shown by a further step 2:9, after the purchase of media object(s) has been executed, the purchase control unit 206 also provides compensation to the media sending party identified from the sender ID, when the user has bought the media object presented by the media sender 202. Finally, the user/subscriber is charged for the purchase, illustrated in a step 2:10, which may be effectuated by means of a regular telephone bill or a separate bill issued for the purchase of media object(s). The charging could also be performed in “real-time”, that is, the sum involved can be deducted from the user's pre-paid account or the like.

The above-described exemplary procedure can be modified in different ways. For example, the step 2:2 of obtaining the media ID and sender ID from media sender 202 may be done in response to the input command of step 2:3, such that terminal 200 then automatically sends a media query to, or “polls”, the media sender 202 regarding what is currently played. Media sender 202 then responds accordingly such that the terminal obtains the media ID and sender ID. In this communication of query and response, the shown NFC units can be used. Alternatively, the media ID and/or sender ID may be conveyed as overlaid, encapsulated or integrated information on the media object being played-out, instead of using a separate communication link or channel. Further, steps 2:7, 2:8, 2:9 and 2:10 are basically independent of each other and can be executed in any suitable order. For example, the user may be charged first and then the media provider may be paid and the media sender be compensated.

The media sender may be implemented in different ways using this solution. For example, the media sender may be a play-out equipment placed in a public space as mentioned above, or even equipment belonging to the user, e.g. a radio receiver placed in the home or car of the user. In that case, the media sender is controlled by the media sending party in the sense of broadcasting the media object presentation and metadata which are sent out by the media sender in the manner described above.

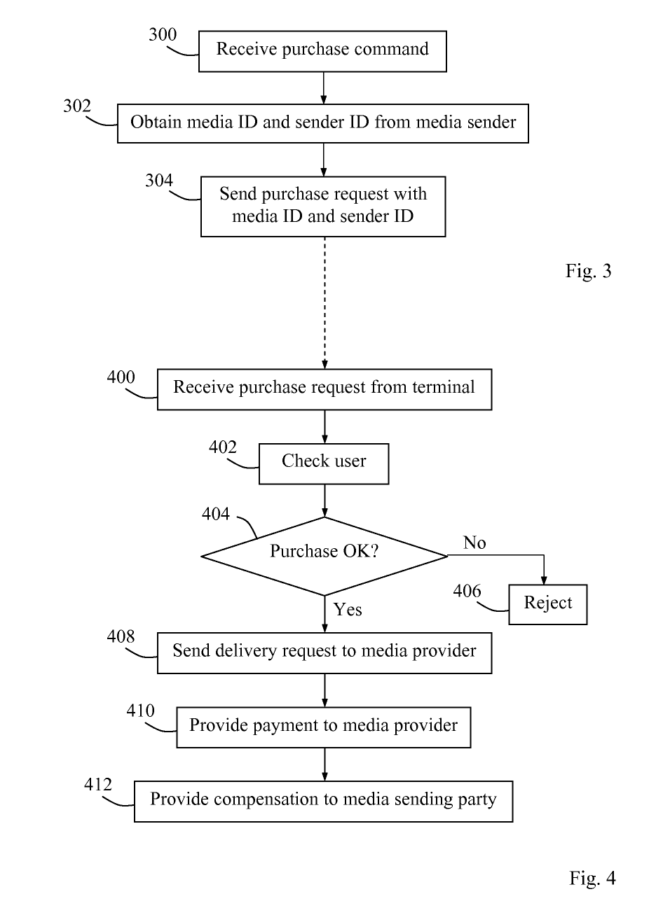

A procedure for enabling a purchase of a media object in accordance with another embodiment, will now be described with reference to FIG. 3 illustrating a flow chart with steps executed in a communication terminal operated by a user. As in FIG. 2, a presentation of the media object is sent out by a media sender to be received by the user, and the media object is owned by a media provider.

In a first step 300, the terminal receives from the user a purchase command for the presented media object, as similar to step 2:3 in the example above. In a next step 302, the terminal obtains a media ID and a sender ID from the media sender, e.g. using a separate NFC link based on Bluetooth or infrared technique. As described above, the media ID and sender ID may be obtained from the media sender automatically during play-out of the media object, e.g. in a separate communication link or as overlaid or integrated information on the media, or in response to a media query made by the terminal upon receiving the purchase command from the user. The operation sequence of steps 300 and 302 can thus be selected in any manner depending on the implementation. Further, the terminal may also obtain a media provider identity from the media sender in the above manner.

The terminal then creates a purchase request message including and referring to the media ID and sender ID, and the message is sent to a purchase control unit or similar functional entity, in a further step 304, as similar to step 2:4 in the example above. The purchase request message may further include a preferred delivery address and also the above-mentioned media provider identity, depending on the implementation. The purchase control unit may be implemented at a home network operator, at the media provider, or at a separate purchase handler. If the requested purchase of media object(s) can be permitted, e.g. as controlled by the home network operator or by the media provider, the terminal and/or user will eventually receive the desired media object from the media provider. The user will also be charged either by the home network operator, e.g. in a regular subscription bill, or in a separate media purchase bill, or by deduction from the user's account. The user will alternatively be charged by the media provider in a suitable bill or invoice.

A procedure for enabling the purchase of a media object in accordance with another embodiment, will now be described with reference to FIG. 4 illustrating a flow chart with steps executed by a purchase control unit, which may belong to home network operator that has a trusted relation with a media provider, or to the media provider itself, or to a separate purchase handler. Again, the media object is presented by a media sender to a user operating a user terminal, and the media object is owned by the media provider. The process of FIG. 4 can be executed as a continuation of steps 300-304 in FIG. 3 executed by the user terminal, as indicated by the dashed arrow.

In a first step 400, a purchase request is received from the user terminal, including and referring to a media ID and a sender ID, which thus basically corresponds to step 304 in the previous figure. The purchase request may further include a specific media provider identity identifying the media provider capable of delivering the media object, and which the terminal may have obtained from the media sender along with the media and sender ID:s. The purchase request may also include a suitable identification of the user and a preferred delivery address.

The purchase control unit then checks whether the user can be permitted to make the purchase, e.g. by checking predefined purchase rules as described above, in a next step 402, to find out if the requested purchase can be permitted. As described above for step 2:5, checking the user, e.g. with respect to the purchase rules, may be dependent on any one or more of the following limitation factors: identity of current terminal user, location of current user, money available on the user's account, previous payments of bills, the amount, size or prize of the requested media, type of requested media, current time of day, week or season, and currently available network bandwidth.

If it is determined in a following step 404 that the purchase cannot be permitted, e.g. as dictated by the purchase rules, a suitable reject message may be sent to the terminal, in a step 406. Otherwise, the purchase is permitted and a delivery request referring at least to the received media ID, and optionally also to the sender ID and preferred delivery address, is given to the media provider, in a further step 408, as similar to step 2:6 in the example above. As mentioned above, the media provider may be identified from the media ID and/or sender ID in the purchase request, or from the specific media provider identity if included in the purchase request.

In a next step 410, the purchase may be cleared with the media provider in a suitable manner, such that payment is provided to the media provider for the media delivery requested in step 408. A final step 412 illustrates that compensation is also provided to the media sending party for the purchase of media object(s), which can be identified from the sender ID in the purchase request received in step 400. At some point in the above procedure if the purchase is allowed after step 404, the purchase control unit may charge the user for the purchase, not shown as a step here.

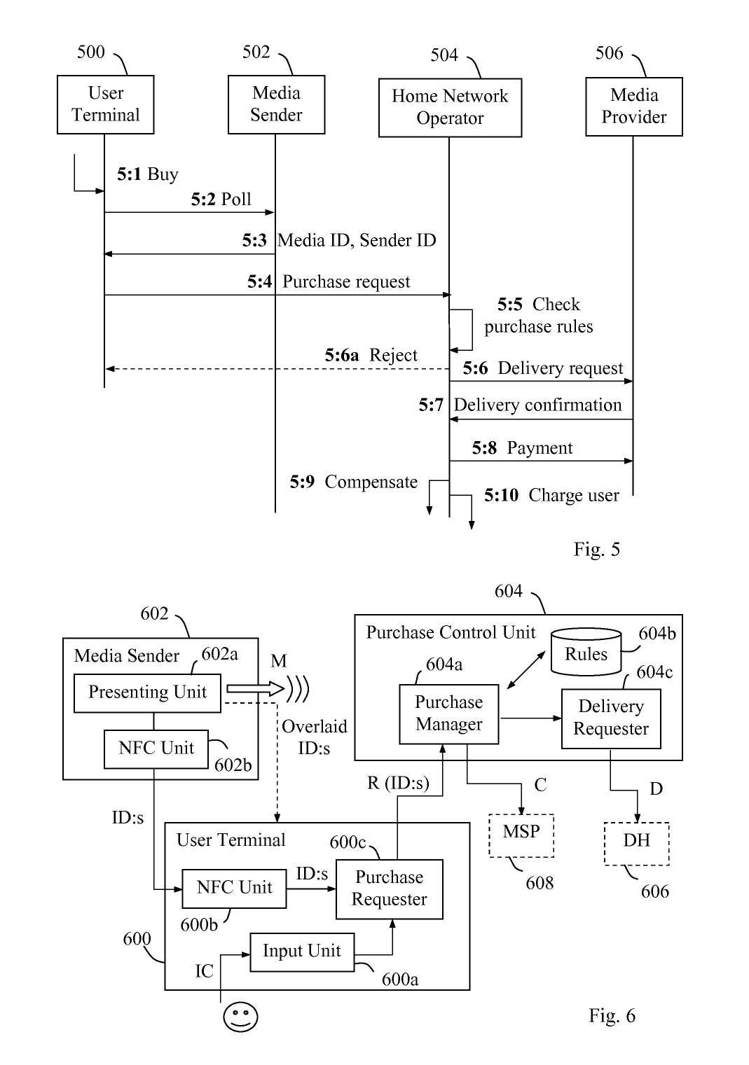

FIG. 5 illustrates a somewhat modified procedure for enabling a purchase of media, with reference to a signalling diagram in accordance with further embodiments. This signalling procedure basically involves a user terminal 500 operated by a current user, a media sender 502 controlled by an affiliate media sending party, a home network operator 504 having the current terminal user as subscriber, and a media provider 506. The functionality of the home network operator 504 may be accomplished by means of a purchase control unit or the like, as described above. Again, it is assumed that a media object owned by media provider 506, is or has been presented by media sender 502, and that home network operator 504 has a trusted relation with media provider 506. Some steps in FIG. 5 are quite similar to corresponding steps in the previous FIGS. 2-4, which will therefore not be described in detail again.

In a first step 5:1, user terminal 500 receives a purchase command from the user for buying the presented media object. In this example, terminal 500 sends a media query or “poll” to the media sender 502, in a next step 5:2, asking media sender 502 to identify the presented media object. In response thereto, media sender 502 sends at least a media ID and a sender ID to the user terminal 500 in a following step 5:3, e.g. using a separate NFC link based on Bluetooth or infrared technique. Although not shown in this example, media sender 502 may also send a media provider identity in this step, depending on the implementation.

In a next step 5:4, terminal 500 creates a purchase request message including at least the obtained media and sender ID:s, and sends the message to the home network operator 504, as also described for steps 304 and 2:4 above. In addition to the media and sender ID:s, the purchase request message may also include a media provider identity, if included in the response message of step 5:3, and a preferred delivery address. Operator 504 then checks the user with respect to predefined purchase rules to determine whether the requested purchase can be permitted, in a next step 5:5, as also described for steps 402 and 2:5 above. Operator 504 further sends a delivery request to media provider 506, in a further step 5:6, as also described for steps 408 and 2:6 above. However, if the purchase cannot be permitted, a suitable reject message may be sent to the user terminal 500 as shown in an alternative step 5:6a.

Relying on the trusted relation with home network operator 504, media provider 506 can now safely deliver the requested media object to the user, not shown as a step here, and then sends a delivery confirmation to the operator 504, in a further step 5:7. In response thereto, operator 504 clears charging with media provider 506 by providing payment to the media provider in a step 5:8, as also described for steps 410 and 2:8 above. Operator 504 also provides compensation to the affiliate media sending party for the purchase of media object(s), in a step 5:9. Finally, home network operator 504 charges the user of terminal 500 for the delivered media object, shown schematically in a last step 5:10, e.g. by a regular telephone bill, or by a separate bill, or by deduction from a pre-paid account.

One skilled in the art will understand that the above-described procedure can be varied in different ways without departing from the invention. For example, step 5:10 of charging the user can be executed before step 5:8 of providing payment to the media provider 506 and/or before step 5:9 of compensating the media sending party. Further, as mentioned above, the media ID and a sender ID may be transmitted separately or conveyed as overlaid information on the presented media object if played out, such that step 5:2 can be omitted.

FIG. 6 is a schematic block diagram illustrating exemplary arrangements in a user terminal 600, a media sender 602 and a purchase control unit 604, which can be used to enable the purchase of a media object from a media provider, basically in accordance with any of the above-described embodiments of FIGS. 2-5. The purchase control unit 604 may be located at, or at least controlled by, any of the media provider, a network operator serving the user, or a separate purchase handler, as described for the above examples.

The user terminal 600 comprises an input unit 600a adapted to receive an input command “IC” from a current user for purchasing a media object being presented, e.g. played out, by media sender 602. User terminal 600 also comprises an NFC unit 600b adapted to obtain a media ID and a sender ID and optionally also a media provider ID, in the figure generally denoted “ID:s”, from the media sender 602 over an NFC link. As described above, the ID:s may be conveyed from the media sender 602 to the terminal 600 during presentation of the media object or in response to a media query made by the terminal upon receiving the purchase command from the user.

Furthermore, NFC unit 600b may also be adapted to receive played-out media as a media stream from media sender 602, and the ID:s may then be received either as overlaid information on the media or over a separate NFC channel. It is also possible to convey different ID:s in different ways to the terminal, e.g. the media ID could be overlaid on the media and the sender and media provider ID:s could be conveyed over a separate NFC channel, or vice versa, without limitation to the invention.

User terminal 600 further comprises a purchase requester 600c adapted to create and send a purchase request “R(ID:s)” to purchase control unit 604 and referring at least to the media ID and sender ID, when the input command IC is received from the user for purchasing the presented media object.

In this example, the media sender 602 comprises a presenting unit 602a adapted to present the media object “M”, such that the presentation is received and experienced by the user of terminal 600, either through a loudspeaker or a video or image playing apparatus. The media object may be sent as a data stream by means of an NFC unit 602b in media sender 602, which is received by NFC unit 600b and played out at the terminal. However, the presenting unit 602a is not limited to any particular presenting technique. The NFC unit 602b is further adapted to send out one or more media related identifications denoted “ID:s” and including at least a media ID that identifies the presented media object, and a sender ID identifying the media sending party, and optionally also a media provider ID as described above.

The ID:s may alternatively be conveyed as overlaid information from the presenting unit 602a, as shown by a dashed arrow. The term “conveying means” is used here to represent the shown NFC unit 600b and/or the presenting unit 602a depending on how the ID:s are conveyed to the terminal 600.

The media ID may be a standardised type of media identity such as CRID, UPC, ISAN or DII, while the sender ID may be an IMS subscriber identity ISIM. It is also possible to send the ID:s above as attributes of an existing metadata format, e.g. the known “Adobe XMP Metadata” format using any of the following attributes as identifier: xmp:identifier or Dublin Core: dc:contributor, dc:publisher and dc:creator. Any of these attributes or identifiers may be either encapsulated in the media object if played-out, or conveyed over a separate NFC link, as described above, and then be extracted by NFC unit 600b at the receiving terminal 600. However, the invention is generally not limited to any particular standards or formats of these media related identifications.

The purchase control unit 604 comprises a purchase manager 604a adapted to receive the purchase request “R(ID:s)” from user terminal 600, including and referring to at least the above media and sender ID:s. The purchase manager 604a may further be adapted to check the user, e.g. with respect to predefined purchase rules stored in a database 604b or the like, to find out if the requested purchase can be permitted, as described above for steps 2:5, 402 and 5:5.

Purchase control unit 604 further comprises a delivery requester 604c adapted to send a delivery request “D” to a delivery handling entity “DH” 606 belonging to the media provider, if the purchase can be permitted, referring to the received media ID and buying user, and optionally also to a preferred delivery address. Purchase manager 604a is further adapted to identify the media sender 602 from the sender ID in the purchase request. The purchase manager 604a is also adapted to provide compensation “C” to the media sending party, schematically illustrated as “MSP” 608, for the user's purchase of the presented media object. The purchase manager 604a may further be adapted to provide payment to the media provider as well (not shown) for delivering the requested media object to the user, and to charge the user for the purchase of media object(s) in a suitable manner (not shown).

It should be noted that FIG. 6 merely illustrates various possible functional units and arrangements in the user terminal 600, media sender 602 and purchase control unit 604 in a logical sense. However, the skilled person is free to implement these functions in practice using any suitable software and hardware means, without limitation to the shown structures.

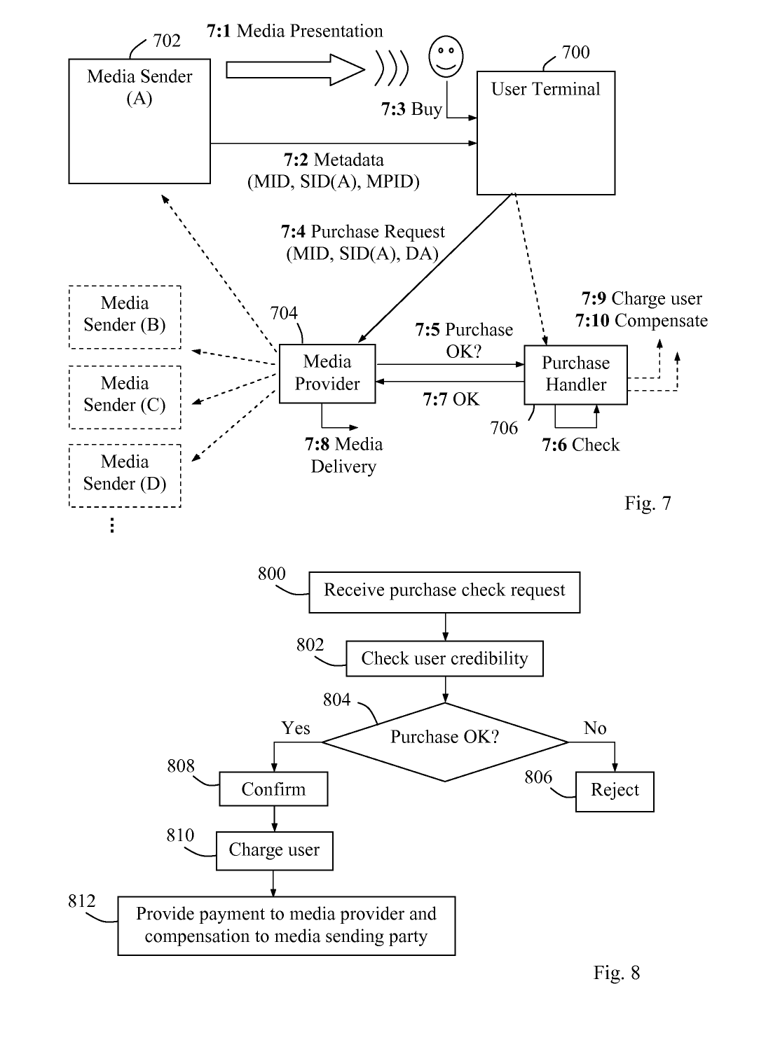

As mentioned above, a purchase of a media object can also be enabled for a terminal user without involving the user's home network operator in the manner described for FIGS. 2-6 above. An exemplary procedure for enabling such a purchase of a media object will now be described with reference to FIG. 7, involving a separate purchase handler 706. As in the previous examples, the user operates a user terminal 700, and the media object or a representation thereof is either played out or otherwise presented by a media sender “A” 702 controlled by a media sending party, as described above. The presented media object is further owned by a media provider 704 which is able to make use of media sender A to promote, advertise or disclose the media object by exposing it to the user. The media provider 704 may affiliate further media senders B, C, D, . . . in a similar manner to promote, advertise or disclose various media objects, e.g. offered for sale, as schematically indicated in the figure.

A first step 7:1 illustrates that the media object is presented by the media sender 702, basically as described for step 2:1 above. In a further step 7:2, the media sender 702 also sends out metadata comprising a media ID denoted “MID” that identifies the presented media object, e.g. in the form of CRID, DII, UPC, ISAN or the above-described metadata attributes, a sender ID denoted “SID(A)” identifying the media sending party of A, and also in this case a media provider ID denoted “MPID” that identifies the media provider 704. SID(A) and MPID may be in the form of ISIM:s or the above-described metadata attributes. It is assumed that the MID, SID(A) and MPID can be received at the terminal 700, e.g. using an NFC unit or otherwise.

The user then makes an input command at the terminal 700 in a next step 7:3 for purchasing the presented media object, and the terminal 700 then sends a purchase request to the media provider 704 identified by the received MPID, in a further step 7:4. In an alternative embodiment, the purchase request may instead be sent to the purchase handler 706, as indicated by a dashed arrow from the terminal 700. The purchase request comprises at least the above MID and SID(A) and may further comprise a preferred delivery address “DA” to which the media object is to be delivered when the purchase is completed.

In a next step 7:5, the media provider 704 having received the purchase request sends a purchase check request or the like to a separate purchase handler 706, referring to the user and the received MID and SID(A), to see if the requested purchase can be permitted and safely executed. Purchase handler 706 then performs a suitable check in a next step 7:6 on the user's credibility and so forth, e.g. with respect to predetermined purchase rules in the manner described above. The process of checking the user at this stage can be made in any prescribed manner without limitation to the invention, e.g. based on the received MID and SID(A). Checking the user may also include contacting a bank of the user, to see if the user can be trusted and/or is capable of paying for the purchase.

If the purchase can be admitted, purchase handler 706 accordingly sends a suitable acknowledge message “OK” in response to the media provider 704, in a further step 7:7. Thereby, the media provider 704 can deliver the media object to the user according to the DA if received, e.g. to the user terminal 700 or to a street address or the like, as schematically illustrated in a following step 7:8. Further, purchase handler 706 also charges the user for the purchase in a suitable manner in a step 7:9.

The media provider 704 is also able to identify the media sending party of A from the SID(A) contained in the received purchase request. In a final step 7:10, purchase handler 706 provides compensation to the media sending party identified from the SID(A) included in the purchase check request of step 7:5, for the user's purchase of the presented media. Alternatively, the media provider 704 may provide the compensation to the media sending party.

FIG. 8 illustrates a procedure with steps executed by a purchase handler for enabling the purchase of a media object basically in accordance with the example of FIG. 7 above. It is thus assumed that a media object owned by a media provider is presented by a media sender and exposed to a terminal user, the media sender being controlled by a media sending party. The user's terminal has further obtained metadata from the media sender comprising at least a media ID or “MID” identifying the presented media object and a sender ID or “SID” identifying the media sending party.

In a first step 800, a purchase check request is received from the media provider which has previously received a purchase request from the user terminal, the purchase check request including and referring to at least the media ID and the sender ID, which thus basically corresponds to step 7:5 in the previous figure. The purchase handler then checks the user's credibility, in a next step 802, to determine whether the requested purchase can be permitted and executed, as similar to step 7:6 in the example above.

If it is determined in a following step 804 that the purchase cannot be permitted, a suitable reject message may be sent to the media provider, in a step 806. If the purchase can be permitted, the purchase handler identifies the media object from the media ID in the received purchase check request, and sends a purchase confirming message to the media provider in a further step 808, as similar to step 7:7 in the example above. Thereby, the media provider can deliver the media object accordingly to the user.

In a next step 810, the purchase handler charges the user for the purchase in a suitable manner. Further, the purchase handler provides payment to the media provider and may also provide compensation for the purchase to the media sending party, which can be identified from the sender ID if received in the purchase check request of step 800, as shown in a final step 812. Alternatively, the compensation to the media sending party may be provided by the media provider upon delivering the media object to the user.

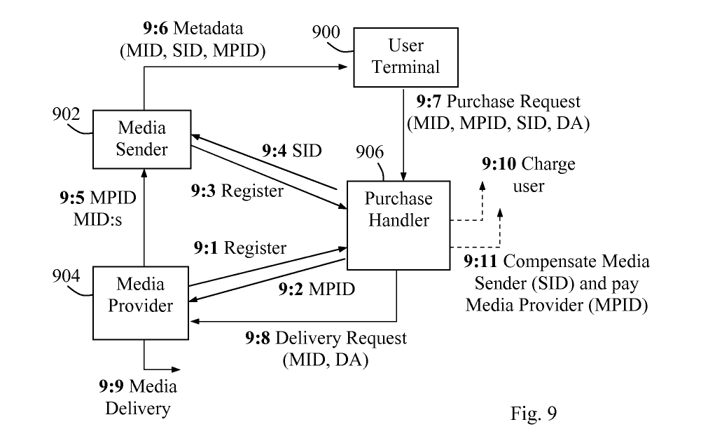

Another exemplary procedure for enabling a purchase of a media object for a terminal user will now be described with reference to FIG. 9. In this example, it is shown particularly how the above-described ID:s can be handled when a separate purchase handler is involved and acting as an administrator of such ID:s. For example, the purchase handler may be controlled by a network operator serving the user.

Thus, the user operates a communication terminal 900 and receives, or is in some manner exposed to, a media object presentation from a media sender 902, the media object being owned by a media provider 904 and the media sender 902 being controlled by a media sending party. The shown purchase procedure is controlled by a purchase handler 906 in a manner to be described below.

Initially, the media sender 902 and media provider 904 register with the purchase handler 906 to obtain their identities SID and MPID, respectively, as illustrated by steps 9:1-9:4. In addition, the media provider 904 defines identities for various media objects as MID:s, and instructs the media sender 902, in a schematic step 9:5, to present one or more of the media objects to terminal users, such as the user of terminal 900. In this step, media provider 904 accordingly conveys its MPID and one or more MID:s to the media sender 902.

A next step 9:6 illustrates that the media sender presents a media object and sends out associated metadata including a corresponding MID as well as the registered SID and MPID, which are received by the terminal 900 in the manner described above. Upon receiving a purchase command from its user, terminal 900 sends a purchase request for the media object which is received by the purchase handler 906 in a step 9:7, the purchase request comprising at least the MID and SID and optionally also the MPID and/or a preferred delivery address DA to which the media object is to be delivered. Alternatively, the delivery address may be derived from the terminal's communication address or telephone number, or may have been preconfigured in the purchase handler 906.

After checking and determining that the requested purchase can be admitted, purchase handler 906 sends a delivery request to the media provider 904, in a further step 9:8, or to an associated delivery handler as mentioned in the example of FIG. 6. The delivery request comprises the MID and DA, although the delivery address may otherwise have been preconfigured in the media provider 904 such that the DA is superfluous in this step. Media provider 904 can then identify the wanted media object from the received MID and deliver it according to the received DA or according to a preconfigured delivery address, in a following step 9:9.

Furthermore, the purchase handler 906 charges the user for the purchase in a step 9:10, and also provides both compensation to the media sending party for the user's purchase of the presented media object and payment to the media provider 904 for delivering the media object to the user, using the received SID and MPID, respectively, as shown in a last schematic step 9:11.

By using the above-described embodiments, a convenient, safe and relatively simple mechanism for purchasing media objects can be obtained requiring a minimum of effort and attention from the user for making such a purchase, which may be particularly desirable for supporting purchase of media object(s) involving small sums, sometimes referred to as “micro-payments”. Another advantage is that the revenue for media object purchases can be shared between the media provider and the media sending party, and optionally also a separate purchase handler if used or the home network operator. In some of the above embodiments, the home network operator or purchase handler can be used as a reliable intermediate party between the user and the media provider when executing the media purchase, also catering for payment, charging and compensation for the purchase.

While the invention has been described with reference to specific exemplary embodiments, the description is generally only intended to illustrate the inventive concept and should not be taken as limiting the scope of the invention, which is defined by the appended claims.

1.-31. (canceled)

32. A method of enabling a purchase of a media object for a user operating a user terminal, the media object being owned by a media provider, comprising:
presenting the media object or a representation thereof to the user by a media sender controlled by a media sending party;
conveying, from the media sender to the user terminal, a media identifier (MID) that identifies the media object and a sender identifier (SID) that identifies the media sending party;
sending, from the user terminal, a purchase request referring to the MID and the SID upon receiving a purchase command from the user;
wherein the media sending party is identified based on the SID in order to provide compensation to the media sending party for the user's purchase of the media object; and
delivering, from the media provider, the media object to the user based on MID in response to the purchase request.

33. The method of claim 32, wherein a media provider identifier (MPID) that identifies the media provider is also conveyed from the media sender to the user terminal.

34. The method of claim 32, wherein at least one of the MID and SID is conveyed from a near-field communication (NFC) unit in the media sender to an NFC unit in the user terminal.

35. The method of claim 34, wherein the media object or representation thereof is played by the media sender, and the user terminal obtains at least one of the MID and SID by sending a media query to the media sender regarding the media object, when receiving the purchase command from the user.

36. The method of claim 32, wherein the media object or representation thereof is played by the media sender and at least one of MID and SID is conveyed from the media sender to the user terminal as overlaid information on the media object.

37. The method of claim 32, wherein the media object or representation thereof is presented to the user by being played out, offered, announced, illustrated, disclosed, or displayed by the media sender.

38. The method of claim 32, wherein a network operator serving the user receives the purchase request, sends a delivery request to the media provider for delivery of the media object to the user, charges the user for purchase of the media object, provides payment to the media provider for delivering the media object, and provides the compensation to the media sending party.

39. The method of claim 38, wherein the network operator has a trusted relation with the media provider, such that the network operator takes responsibility for charging the user and providing payment to the media provider for purchase of the media object, and the media provider delivers the media object to the user.

40. The method of claim 32, wherein the user is checked with respect to predefined purchase rules to determine whether purchase of the media object is permitted.

41. The method of claim 40, wherein the predefined purchase rules depend on at least one of identity of current terminal user; location of current user; previous payments of bills; money available in a user account; a sum, size, or price of the media object; a type of media object; a current time of day, week, or season; and currently available network bandwidth.

42. The method of claim 41, wherein the purchase rules differentiate different users or terminals.

43. The method of claim 32, wherein the media provider or a separate purchase handler receives the purchase request, checks the user's credit to determine whether purchase of the media object is permitted, and provides compensation to the media sending party.

44. An arrangement in a media sender for enabling purchase of a media object for a user operating a user terminal, the media object being owned by a media provider and the media sender being controlled by a media sending party, comprising:
a presenting unit adapted to present the media object or a representation thereof to the user, and
a conveyor adapted to convey a media identifier (ID) to the user terminal that identifies the media object, and to convey a sender ID to the user terminal that identifies the media sending party,
wherein the user terminal is configured to make a purchase request referring to the media ID and sender ID upon receiving a purchase command from the user, thereby enabling the media sending party identified based on the sender ID to receive compensation for purchase of the presented media object, and the media object is delivered to the user by the media provider based on the media ID in response to the purchase request.

45. The arrangement of claim 44, further comprising a near-field communication (NFC) unit adapted to send out at least one of the media ID and sender ID over an NFC link.

46. The arrangement of claim 45, wherein the NFC unit is further adapted to send out at least one of the media ID and sender ID in response to a media query from the user terminal regarding the media object.

47. The arrangement of claim 44, wherein the presenting unit is further adapted to play at least a part of the media object, and to convey at least one of the media ID and sender ID to the user terminal as overlaid information on the part of the media object.

48. The arrangement of claim 44, wherein the conveyor is also adapted to convey a media provider ID to the user terminal that identifies the media provider.

49. An arrangement in a user terminal for enabling purchase of a media object for a user operating the user terminal, wherein the media object or a representation thereof is presented by a media sender to the user, the media object is owned by a media provider, and the media sender is controlled by a media sending party, the arrangement comprising:
an input unit adapted to receive an input command from the user for purchasing the media object,
a device configured for obtaining from the media sender a media identifier (ID) that identifies the media object and a sender ID that identifies the media sending party, and
a purchase requester adapted to make a purchase request referring to the obtained media ID and sender ID when receiving the input command,
wherein the media provider is enabled to deliver the media object based on the media ID in response to the purchase request, and identification of the media sending party is enabled based on the sender ID in order to provide compensation to the media sending party for purchase of the media object.

50. The arrangement of claim 49, wherein the obtaining device comprises a near-filed communication (NFC) unit adapted to receive the media ID and sender ID from the media sender over an NFC link.

51. The arrangement of claim 50, wherein the media object or representation thereof is played by the media sender and the NFC unit is further adapted to receive the media ID and sender ID from the media sender during play of the media object.

52. The arrangement of claim 50, wherein the NFC unit is further adapted to send a media query to the media sender regarding the media object upon receiving the input command from the user, and to receive the media ID and sender ID in response to the media query.

53. The arrangement of claim 49, wherein the media object or representation thereof is played by the media sender, and the obtaining device is further adapted to receive the media ID and sender ID as overlaid information on the media object or representation thereof.

54. The arrangement of claim 49, wherein the purchase requester is further adapted to send the purchase request to the media provider, a network operator serving the user, or a separate purchase handler.

55. An arrangement in a purchase control unit configured to enable purchase of a media object for a user operating a user terminal, wherein the media object or a representation thereof is presented by a media sender to the user, the media object being owned by a media provider and the media sender being controlled by a media sending party, comprising:
a purchase manager adapted to receive a purchase request from the terminal referring to a media identifier (ID) that identifies the media object and a sender ID that identifies the media sending party, wherein the user terminal has obtained the media ID and sender ID from the media sender, and
a delivery requester adapted to send a delivery request to the media provider or to an associated separate delivery handler referring to the media ID such that the media object can be delivered to the user by the media provider based on the media ID in response to the purchase request,
wherein the purchase manager is further adapted to identify the media sending party based on the sender ID and to provide compensation to the media sending party for purchase of the media object.

56. The arrangement of claim 55, wherein the purchase manager is further adapted to check the user with respect to predefined purchase rules to determine whether purchase of the media object is permitted.

57. The arrangement of claim 56, wherein the predefined purchase rules depend on at least one of an identity of a current terminal user; a location of the current user; previous payments of bills; money available in a user account; a sum, size, or price of the media object; a type of media object; a current time of day, week, or season; and a currently available network bandwidth.

58. The arrangement of claim 57, wherein the purchase rules differentiate different users or terminals, depending on which user has logged on to the terminal, or capabilities of the terminal.

59. The arrangement of claim 55, wherein the purchase manager is further adapted to provide payment to the media provider for purchase of the media object, and to charge the user for the purchase.

60. The arrangement of claim 55, wherein the purchase control unit is located at or controlled by the media provider, a network operator serving the user, or a separate purchase handler.

61. A method in a media provider of enabling a purchase of a media object for a user operating a user terminal, the media object being owned by the media provider, wherein the media object or a representation thereof is presented to the user by a media sender controlled by a media sending party, comprising:
receiving a purchase request from the user terminal referring to a media identifier (ID) that identifies the media object and a sender ID that identifies the media sending party, wherein the terminal has obtained the media ID and sender ID from the media sender;
delivering the media object to the user based on the media ID in response to the purchase request; and
identifying the media sending party based on the sender ID and providing compensation to the media sending party for purchase of the media object.

62. The method of claim 61, wherein the purchase request also refers to a preferred delivery address, and the media object is delivered to the preferred delivery address.
